(19) United States
(12) Patent Application Publication
(10) Pub. No.: US 2016/0086203 A1
(43) Pub. Date: Mar. 24, 2016

(54) Dynamic Polling Based on Location and Time

(71) Applicant: Brilliant Lime, Inc., Cheyenne, WY (US)

(72) Inventors: Michael E. Dove, Los Gatos, CA (US); Edward H. Frank, Atherton, CA (US)

(73) Assignee: Brilliant Lime, Inc., Cheyenne, WY (US)

(21) Appl. No.: 14/851,831

(22) Filed: Sep. 11, 2015

Related U.S. Application Data
(60) Provisional application No. 62/071,449, filed on Sep. 23, 2014.

(51) Int. Cl. G06Q 30/02

(52) U.S. Cl. CPC G06Q 30/0203

(57) ABSTRACT

In order to conduct a poll, a computer system (such as a server) identifies a subset of users based on their current locations, the current time and/or predefined profiles of the users (which specify user preferences and demographic information). Then, the computer system provides, to the portable electronic devices (such as cellular telephones) associated with the identified subset of the users, the poll with a query and predefined potential answers. Next, the computer system receives, from at least a subset of the portable electronic devices, responses to the poll, where a given response includes at least one of the predefined potential answers as a selected answer. Furthermore, the computer system may perform one or more additional operations based on the given response. For example, the computer system may provide a results summary of the selected answers received from other portable electronic devices associated with the subset of the users.

### CROSS-REFERENCE TO RELATED APPLICATION

This application claims priority under 35 U.S.C. §119(e) to U.S. Provisional Application Ser. No. 62/071,449, entitled “Dynamic Polling Based on Location and Time,” by Michael E. Dove and Edward H. Frank, Attorney docket number CP-001, filed on Sep. 23, 2014, the contents of which are herein incorporated by reference.

This application is related to U.S. Non-provisional application Ser. No. ______, entitled “Navigating Through Information Based on Poll Responses,” by Michael E. Dove and Edward H. Frank (Attorney Docket Number CP-1402), filed on Nov. ______, 2014; and to U.S. Non-provisional application Ser. No. ______, entitled “Correcting for Poll Bias,” by Michael E. Dove and Edward H. Frank (Attorney Docket Number CP-1403), filed on Nov. ______, 2014, the contents of both of which are herein incorporated by reference.

### BACKGROUND

1. Field

The described embodiments relate to techniques for providing polls to individuals. More specifically, the described embodiments relate to techniques for dynamically providing polls to individuals based on their location, the time, and/or user profiles.

2. Related Art

Opinion polls are a popular technique for surveying public opinion in a particular sample or subset of a population. These opinion polls are usually designed to represent the opinions of the population by extrapolating the answers to a series of questions from the sample or subset. For example, opinion polls may be used to predict voter intent or to assess attitudes about an institution, such as a company.

Traditionally, opinion polls have been conducted in person or via telephone. More recently, polling techniques have been extended to leverage improvements in computer and telecommunications technology. Consequently, many polls, such as quality surveys, are now conducted online.

However, polls are subject to a wide variety of biases that can distort their results, including: nonresponse bias (in which some individuals may not respond to a poll), response bias (in which respondents answers may not reflect their true beliefs), bias associated with the questions, and coverage bias (in which the sample or subset may not be representative of the population). Pollsters typically employ a variety of techniques (such as the use of multiple different samples or subsets) in an attempt to identify and correct for these biases. These correction techniques are time-consuming and expensive, which often makes difficult to conduct polls in a cost-effective and an efficient manner.

### SUMMARY

The described embodiments relate to a computer system that conducts a poll. This computer system includes: an interface circuit that communicates with portable electronic devices via a network; a processor; and memory, coupled to the processor, which stores location information, timestamps and predefined profiles of users, and which stores a program module that is executed by the processor to provide the poll. During operation of the computer system, the program module accesses, at memory locations, the location information, the timestamps and the predefined profiles of users, where the location information specifies locations of the portable electronic devices associated with the users at the timestamps, and the predefined profiles specify user preferences and demographic information. Then, the program module identifies a subset of the users based on the location information, the timestamps and the predefined profiles. Furthermore, the program module provides, to the portable electronic devices associated with the identified subset of the users, the poll with a query and predefined potential answers. Next, the program module receives, from at least a subset of the portable electronic devices, responses to the poll, where a given response includes at least one of the predefined potential answers as a selected answer.

In some embodiments, the program module provides, to a portable electronic device associated with the given response, a results summary of the selected answers received from other portable electronic devices associated with the subset of the users. For example, the results summary may include: a most-common selected answer, selection probabilities of the predefined potential answers, and/or one or more correct answers to the query. Moreover, for a given user, the results summary may include the responses and identities of one or more users in the subset of the users associated with the given user, where the one or more users are specified in a predefined profile of the given user. Note that the received responses may include user-defined answers to the query.

Furthermore, providing the poll may be gated by predefined disturbance conditions of the subset of the users, where a predefined disturbance condition of the given user indicates where and when the given user receives polls.

Additionally, the poll may have an associated start timestamp and an associated end timestamp, where the poll is provided to the subset of the users when a current timestamps is between the start timestamp and the end timestamp.

In some embodiments, the given user is included in the subset of the users based on whether the given user responded to a previous poll and a selected answer to the previous poll.

Moreover, there may be multiple versions of the poll, and a given portable electronic device may receive one of the versions of the poll.

Another embodiment provides a computer-program product for use with the computer system described previously. This computer-program product includes instructions for at least some of the operations performed by the computer system.

Another embodiment provides a method for conducting the poll described previously. This method includes at least some of the operations performed by the computer system.

Another embodiment provides one of the portable electronic devices described previously.

Another embodiment provides a computer-program product for use with the portable electronic device. This computer-program product includes instructions for counterpart operations to at least some of the operations performed by the computer system, which are performed by the portable electronic device.

Another embodiment provides a method for conducting the poll described previously. This method includes counterpart operations to at least some of the operations performed by the computer system, which are performed by the portable electronic device.

This Summary is provided merely for purposes of illustrating some exemplary embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating electronic devices wirelessly communicating in accordance with an embodiment of the present disclosure.

FIG. 2 is a flow diagram illustrating a method for conducting a poll via the electronic devices in FIG. 1 in accordance with an embodiment of the present disclosure.

FIG. 3 is a flow diagram illustrating a method for conducting a poll via the electronic devices in FIG. 1 in accordance with an embodiment of the present disclosure.

FIG. 4 is a drawing illustrating communication among the electronic devices in FIG. 1 in accordance with an embodiment of the present disclosure.

FIG. 5 is a drawing illustrating a sequence of user interfaces displayed on one of the electronic devices in FIG. 1 in accordance with an embodiment of the present disclosure.

FIG. 6 is a drawing illustrating a sequence of user interfaces displayed on one of the electronic devices in FIG. 1 in accordance with an embodiment of the present disclosure.

FIG. 7 is a drawing illustrating a sequence of user interfaces displayed on one of the electronic devices in FIG. 1 in accordance with an embodiment of the present disclosure.

FIG. 8 is a drawing illustrating a sequence of user interfaces displayed on one of the electronic devices in FIG. 1 in accordance with an embodiment of the present disclosure.

FIG. 9 is a drawing illustrating a sequence of user interfaces displayed on one of the electronic devices in FIG. 1 in accordance with an embodiment of the present disclosure.

FIG. 10 is a drawing illustrating a sequence of user interfaces displayed on one of the electronic devices in FIG. 1 in accordance with an embodiment of the present disclosure.

FIG. 11 is a flow diagram illustrating a method for navigating through information using the electronic devices in FIG. 1 in accordance with an embodiment of the present disclosure.

FIG. 12 is a flow diagram illustrating a method for navigating through information using the electronic devices in FIG. 1 in accordance with an embodiment of the present disclosure.

FIG. 13 is a drawing illustrating communication among the electronic devices in FIG. 1 in accordance with an embodiment of the present disclosure.

FIG. 14 is a drawing illustrating a sequence of user interfaces displayed on one of the electronic devices in FIG. 1 in accordance with an embodiment of the present disclosure.

FIG. 15 is a flow diagram illustrating a method for correcting for bias in a poll in accordance with an embodiment of the present disclosure.

FIG. 16 is a flow diagram illustrating a method for correcting for bias in a poll in accordance with an embodiment of the present disclosure.

FIG. 17 is a drawing illustrating communication among the electronic devices in FIG. 1 in accordance with an embodiment of the present disclosure.

FIG. 18 is a drawing illustrating correcting for bias in a poll in accordance with an embodiment of the present disclosure.

FIG. 19 is a block diagram illustrating one of the electronic devices of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to conduct a poll, a computer system (such as a server) identifies a subset of users based on their current locations, the current time and/or predefined profiles of the users (which specify user preferences and/or demographic information). Then, the computer system provides, to portable electronic devices (such as cellular telephones) associated with the identified subset of the users, the poll with a query and predefined potential answers. Next, the computer system receives, from at least a subset of the portable electronic devices, responses to the poll, where a given response includes at least one of the predefined potential answers as a selected answer. Furthermore, the computer system may perform one or more additional operations based on the given response. For example, the computer system may provide a results summary of the selected answers received from other portable electronic devices associated with the subset of the users.

By conducting the poll based on the current locations, the time and/or the predefined profiles, this polling technique may facilitate dynamic polling. These polls may be used for a wide variety of purposes beyond those of traditional polls. As such, the accuracy of the polling results may not always, per se, be as important. (However, in other embodiments the accuracy of the polls may be important, and the polls may be corrected to compensate for or to eliminate one or more biases.) Consequently, the polls may be used to communicate information to an audience of users in a low-cost and efficient manner. These polls may provide a dynamic and targeted mechanism for people to interact with each other and/or for organizations (such as companies, governments, non-profit organizations and, more generally, groups of individuals) to interact with potential customers. Therefore, the polling technique may improve the user experience when using the portable electronic devices, which may increase user retention and engagement in a social network that implements the polling technique.

In the discussion that follows, an individual or a user may include a person (for example, an existing user of the social network or a new user of the social network). Also, or instead, the polling technique may be used by an organization, a business, and/or a government agency. Furthermore, a ‘business’ should be understood to include for-profit corporations, non-profit organizations, groups (or cohorts) of individuals, sole proprietorships, government agencies, partnerships, etc.

Moreover, in the discussion that follows, the portable electronic devices may include a radio that communicate packets (and, more generally, information) in accordance with a cellular-telephone communication protocol (e.g., a so-called third-generation or 3G communication protocol, a 3.5G communication protocol, 4G communication protocol, such as Long Term Evolution, etc.). However, a wide variety of other communication protocols may be used, including: an Institute of Electrical and Electronics Engineers (IEEE) 802.11 standard (which is sometimes referred to as ‘Wi-Fi,’ from the Wi-Fi Alliance of Austin, Tex.). Bluetooth (from the Bluetooth Special Interest Group of Kirkland, Wash.), and/or another type of communication protocol.

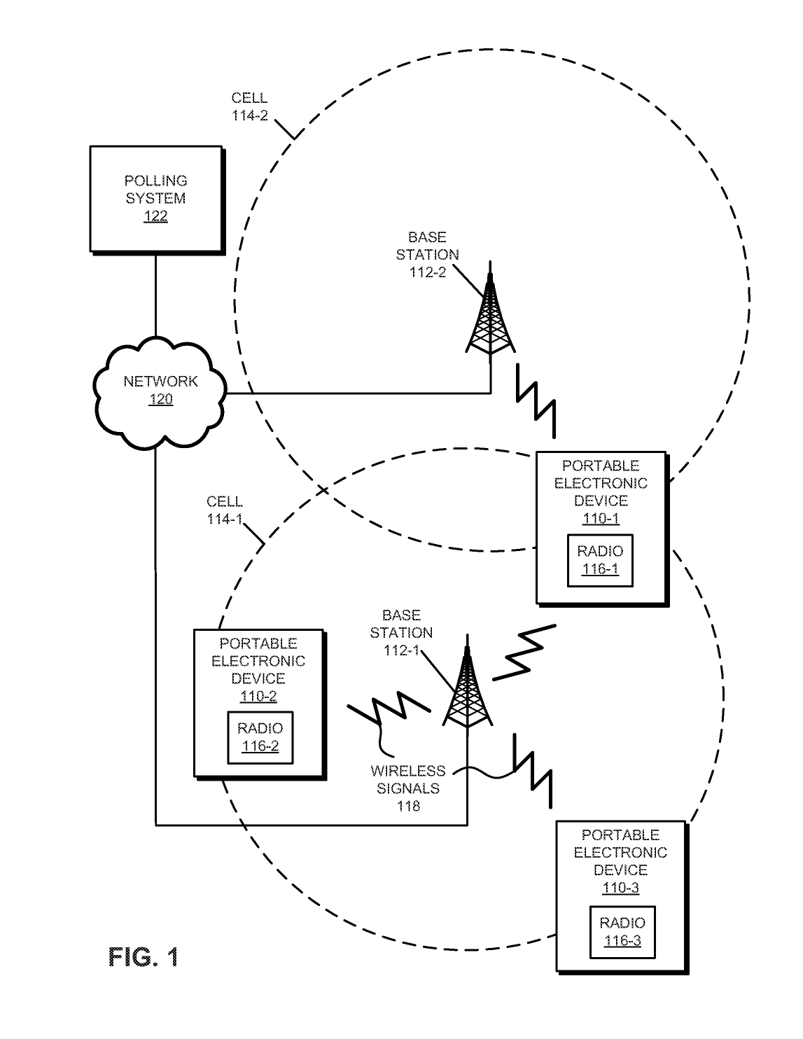

Communication among portable electronic devices is shown in FIG. 1, which presents a block diagram illustrating one or more portable electronic devices 110 (such as cellular telephones) wirelessly communicating with base stations 112 in a cellular-telephone network. In particular, these portable electronic devices may wirelessly communicate while communicating packets via one or more base stations 112 that currently provide cellular service to portable electronic devices 110 in cells 114.

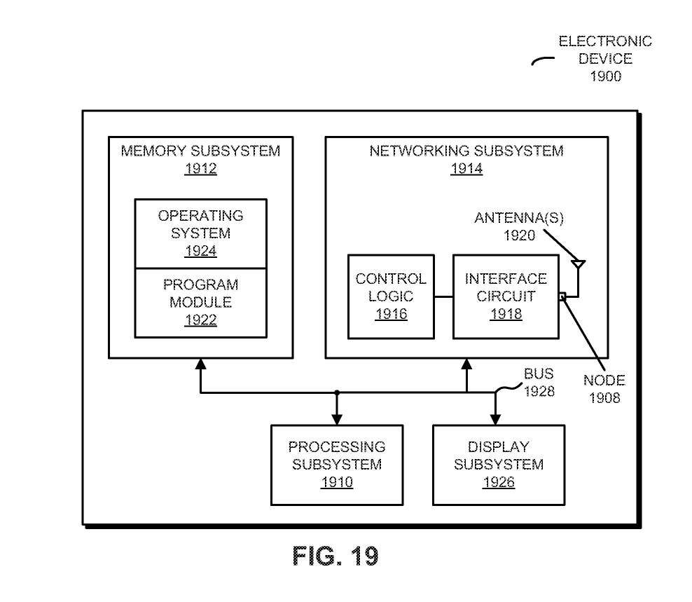

As described further below with reference to FIG. 19, each of portable electronic devices 110 may include subsystems (such as a networking subsystem, a memory subsystem and a processor subsystem) that facilitate the wireless communication. In particular, portable electronic devices 110 may include radios 116 in the networking subsystems. More generally, portable electronic devices 110 can include (or can be included within) any electronic devices with the networking subsystems that enable portable electronic devices 110 to wirelessly communicate via the cellular-telephone network.

This communication can comprise: transmitting messages on wireless channels to enable portable electronic devices 110 to make initial contact, followed by exchanging subsequent messages to establish or maintain a connection, and transmitting and receiving packets or frames via the connection, etc. As can be seen in FIG. 1, wireless signals 118 (represented by jagged lines) are communicated with base stations 112 in cells 114 using radios 116 in portable electronic devices 110.

In the described embodiments, processing a packet or frame in portable electronic devices 110 includes: receiving wireless signals 118 with the packet or frame; decoding/extracting the packet or frame from received wireless signals 118 to acquire the packet or frame; and processing the packet or frame to determine information contained in the packet or frame (such as a poll, a summary report, an incentive and/or other information in the payload).

During the polling technique, a computer system, such as polling system 122 (which may implement the social network that provides polls), may receive location information and associated timestamps (such as a date and a time) from one or more of base stations 12 via network 120 (such as the Internet). The location information and timestamps may specify the location of portable electronic devices 110 as function of time. Alternatively or additionally, the location information may be provided by a wireless network (such as a Wi-Fi network), a local positioning system and/or a global positioning system. In general, the location of portable electronic devices 110 may be determined using: proximity to an access point or a transmitter, triangulation, and/or trilateration.

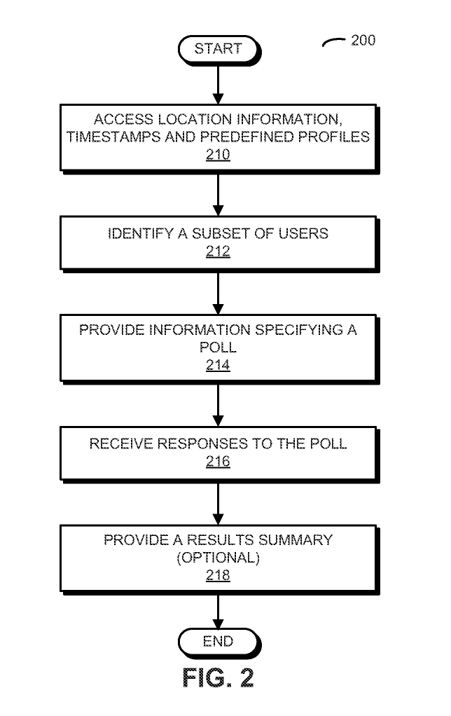

Then, using the location information, the timestamps, predefined profiles of users of portable electronic devices 110 (who may be users of the social network), polling system 122 may selectively and dynamically provide polls, via the cellular-telephone network, to at least a subset of portable electronic devices 110 (and, thus, at least a subset of the users). In particular, as discussed further below with reference to FIGS. 2-4, in the disclosed polling technique polling system 122 may identify the subset of the users based on the location information, the timestamps and/or the predefined profiles (such as user preferences and demographic information). Note that the given poll may include one or more queries and the associated predefined potential answers (such as predefined categorical potential answers). In general, the given poll may include content or information associated with the one or more queries and the associated predefined potential answers, including: text or alphanumerical characters, layout information (including fonts, colors, positions and/or ordering of the predefined potential answers), pictures, audio, video, and/or additional information (such as links to documents, e.g., a web page, on network 120, text messages and/or chat conversations). Furthermore, note that the predefined profiles may be provided by the users when they establish accounts with a provider of the social network. In some embodiments, the users provide the information in the profiles by answering questions or queries in one or more of the polls.

After identifying the subset, polling system 122 may provide information specifying one or more polls to the associated subset of portable electronic devices 110 via the cellular-telephone network. The one or more polls may be received by the subset of portable electronic devices 110, and may be presented to the subset of the users using displays (and, more generally, user interfaces) in the subset of portable electronic devices 110. In particular, instances of a polling application (and, more generally, software), which execute in an environment (such as an operating system) of portable electronic devices 110, may present the one or more polls. When the subset of portable electronic devices 110 receives the one or more polls, the one or more polls (including the queries and the predefined potential answers) may be presented to the users by the polling application.

Note that the instances of the polling application may be installed on portable electronic devices 110. In some implementations, the users may interact with a web page that is provided by polling system 122 via network 120, and which is rendered by web browsers on portable electronic devices 110. For example, at least a portion of the polling application executing on portable electronic devices 110 may be an application tool that is embedded in the web page, and that executes in a virtual environment of the web browsers. Thus, the application tool may be provided to the users via a client-server architecture. Alternatively, the polling application may be a standalone application or a portion of another application that is resident on and that executes on portable electronic devices 110 (such as a software application that is provided by polling system 122 or that is installed on and that executes on portable electronic devices 110).

For the given poll, a user (such as a user of portable electronic device 110-1) may select one or more of the predefined potential answers using a user interface. For example, the user may use a keyboard, a mouse, a touchpad, a cursor and/or a virtual icon on a multi-touch screen to select or activate one or more of the predefined potential answers, which is sometimes referred to as the ‘selected answer.’ (However, in some embodiments the selected answer includes a null value when the user does not respond to a poll.) Alternatively or additionally, in some embodiments the user may provide their own user-defined (free-form) answer(s) to the query (e.g., using the keyboard or the multi-touch screen) in a text-entry box or control object. Then, portable electronic device 110-1 may provide, via the cellular-telephone network, the response of the user to the poll (which includes the selected answer) to polling system 122. In some embodiments, the user may provide questions and/or answers using at least one of: audio, images, video and, more generally, rich media.

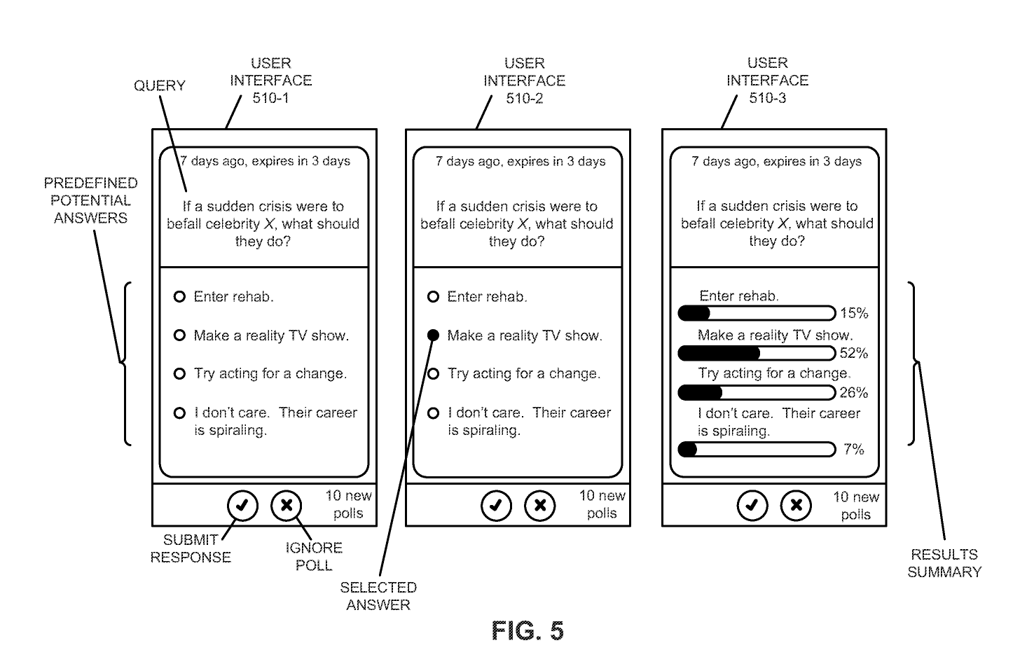

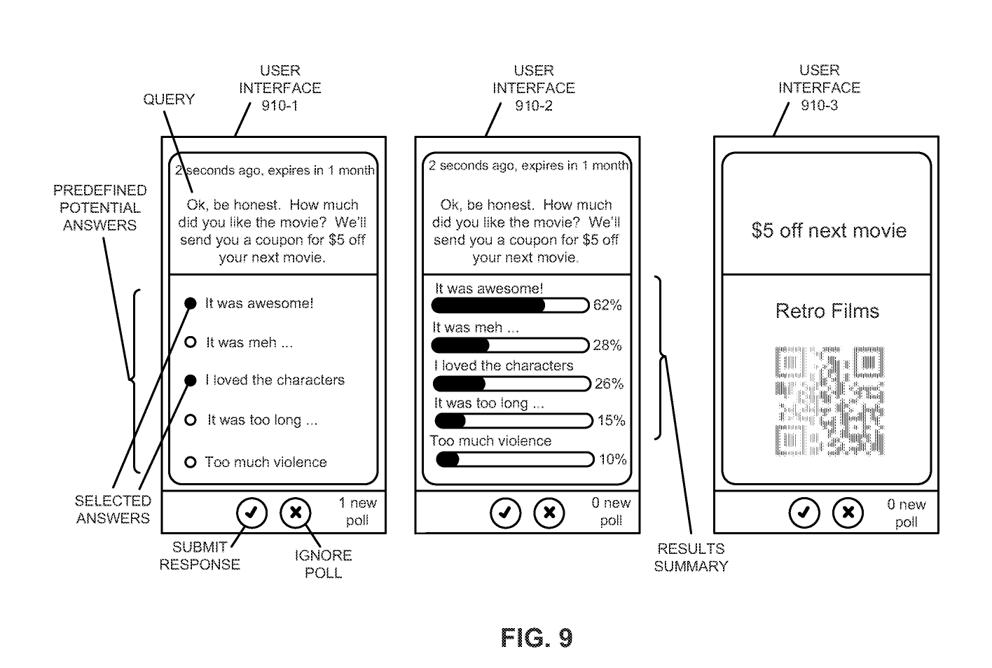

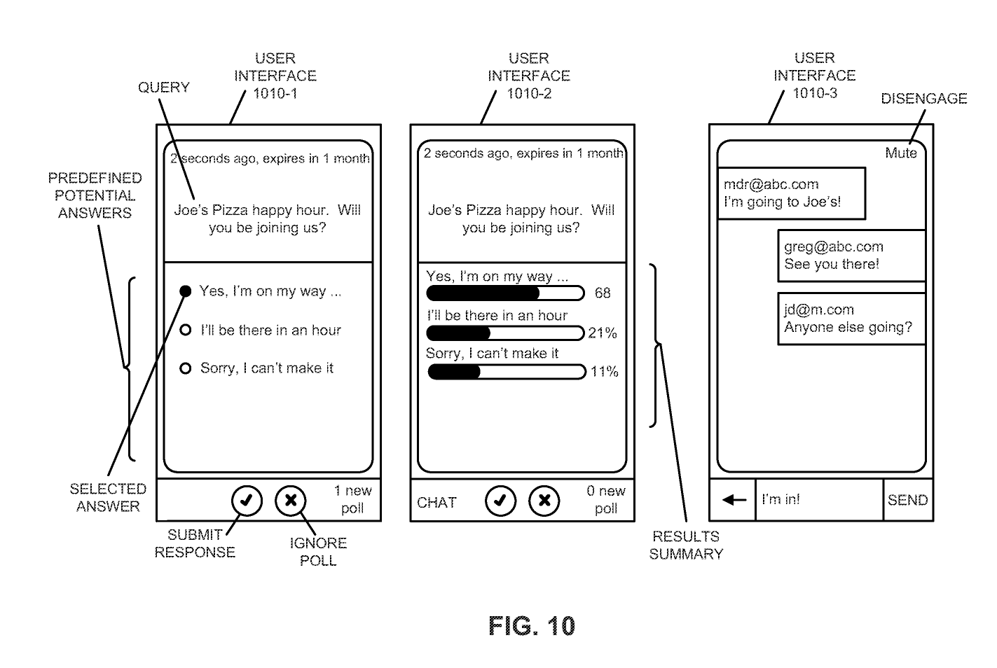

Polling system 122 may aggregate the responses of the subset of the users, which may be stored in a data structure in a computer-readable storage medium, such as a memory in or accessible by polling system 122. (This aggregated information may include useful information about who responded, when they responded and where they were when they responded, which may be used to conduct subsequent polls and/or which may be valuable for advertisers in the social network.) In addition, in response to receiving the responses from at least some of the subset of portable electronic devices 110, polling system 122 may provide, via the cellular-telephone network, additional information to at least some of the subset of portable electronic devices 110. For example, as described further below with reference to FIG. 5, polling system 122 may provide to portable electronic devices 110-1 a results summary of the selected answers received from other portable electronic devices in the subset of portable electronic devices 110, which may be presented by the polling application to the users. The results summary may include: a most-common selected answer, selection probabilities of the predefined potential answers, and/or one or more correct answers to the query in the poll. Alternatively or additionally, as described further below with reference to FIG. 9, the additional information may include a reward or an incentive (such as a coupon or a discount targeted at the user) based on the received responses. As described further below with reference to FIG. 10, in some embodiments the additional information includes text messages and/or a chat conversation between at least two of the users.

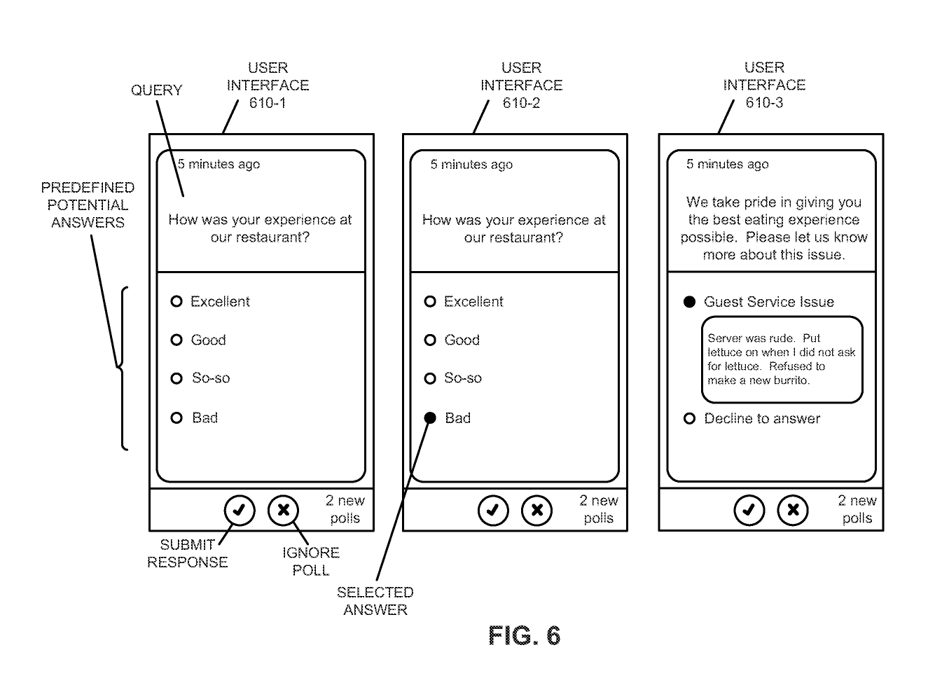

Moreover, as described further below with reference to FIG. 6, the given poll may be provided to the user (i.e., the user may be included in the subset of the users) based on whether the given user responded to a previous poll and a selected answer to the previous poll. For example, the previous poll may have queried the user about their attitudes about a particular brand, such as the quality of service received at a restaurant. If the user complained (as indicated by the selected answer), the user may subsequently receive another poll associated with this brand, which may obtain more information from the user and/or which may attempt to address the user's complaint (e.g., by providing a financial incentive, such as a coupon or a targeted discount to the user). Thus, these so-called ‘linked polls’ allow future polls to be based on the responses or the lack of responses to previous polls.

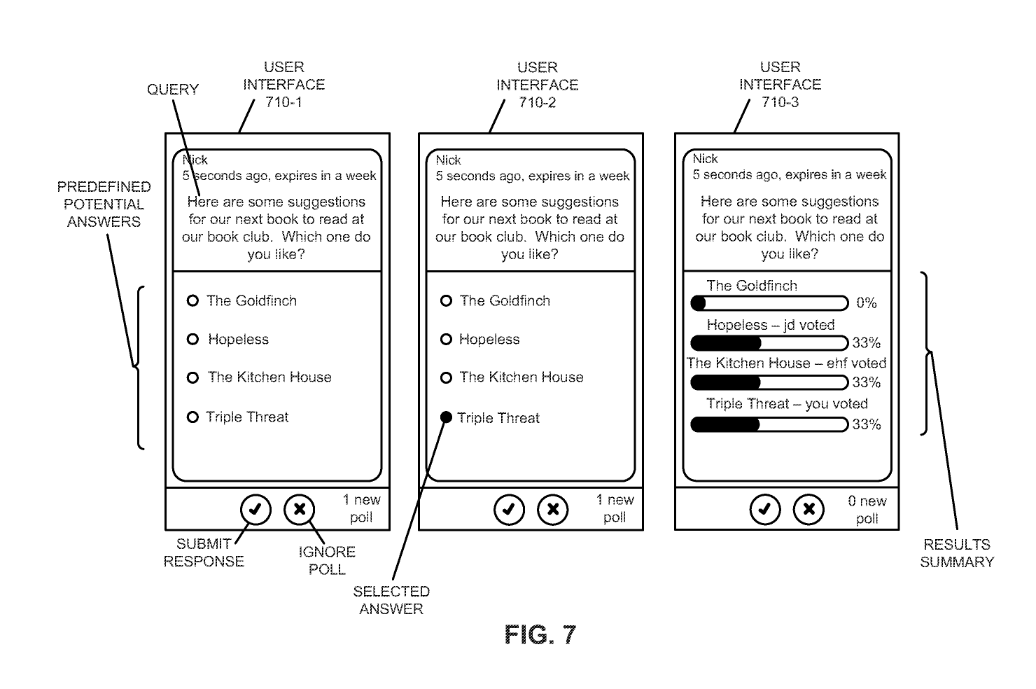

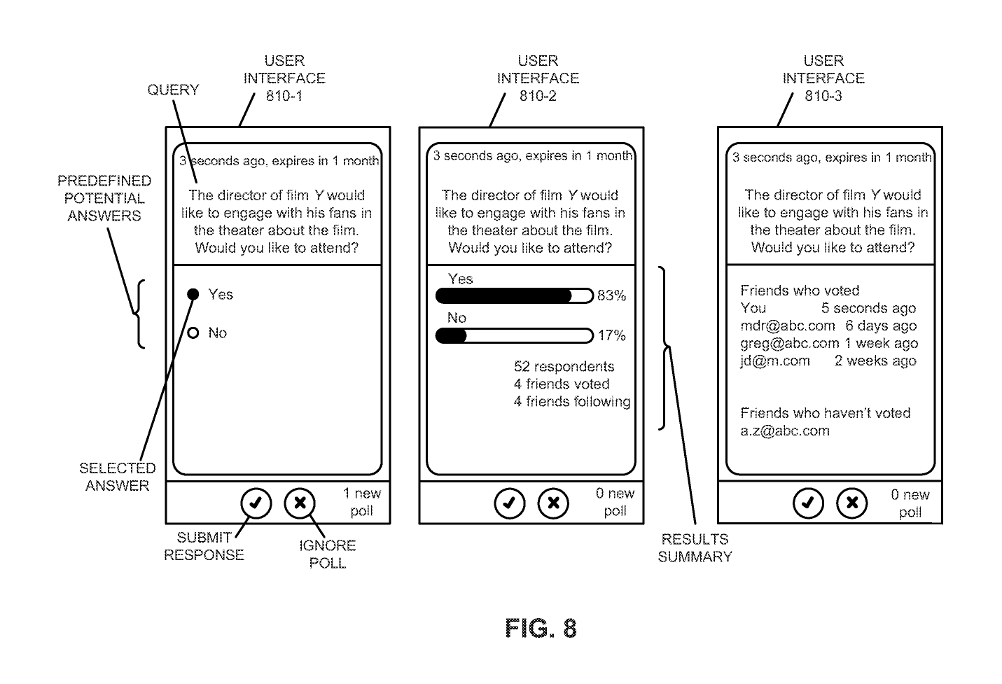

Furthermore, as described further below with reference to FIGS. 7 and 8, polling system 122 may be used to conduct polls among a group of affiliated individuals, such as a group of friends (which is sometimes referred to as a ‘friend poll’). Note that instead of identifying the subset of the users, for a friend poll polling system 122 may use a predefined group of users (such as predefined friends or colleagues of an initiator of the poll) for the subset of users. In these embodiments, the results summary provided in response to receiving the responses includes the responses and the identities of one or more users in the subset of the users associated with the user. For example, these users may be friends of the user, which may be specified in a predefined profile of the user. In particular, the predefined profile may include individuals that have accepted connect requests from the user.

The polls provided by polling system 122 may be gated based on predefined disturbance conditions (or delivery criteria) of the subset of the users. For example, predefined disturbance conditions or criteria of the users may indicate where and when the users receive polls. Thus, a user may specify locations or times of day when the user does not want to receive polls, such as when the user is at home sleeping or when the user is at work. In addition, the user may specify the number of polls per time interval (such as per hour or per day) that they wish to receive. The predefined disturbance conditions or criteria may be stored in a data structure in computer-readable storage medium, such as memory in or accessible by polling system 122.

Moreover, the polls may be specified or defined in advance. For example, one of the users of portable electronic devices 110 may define a poll for their friends via a portal (such as an application programming interface) to polling system 122. Alternatively, an advertiser may define one or more polls as part of an advertising campaign via the portal. Note that specifying a poll may include providing information, such as: one or more queries, one or more potential answers, one or more optional correct answers, a layout of the poll (including the color, font and order or position of displayed content), associated content (such as pictures, audio, text, video, etc.), links to related content, an optional target audience (such as demographic information specifying recipients of the poll), and/or a budget (such as how much money is available, as well as constraints on how and when these funds are used). In some embodiments, there may be multiple versions of a poll (with different layouts, colors, queries and/or predefined potential answers), and a given portable electronic device (such as portable electronic device 110-1) may receive one of the versions of the poll.

In addition, the poll may have associated spatial and temporal constraints. In particular, the spatial constraint(s) may indicate locations (such as in proximity to a restaurant or a retail establishment, in a building, on the grounds of a school, within a city, within a region, within a state, etc.) where the poll is provided to the identified subset. Note that the spatial constraint(s) may be explicitly specified (such as particular locations or addresses) and/or implicitly specified (such as based on user interest in a product, or a chain of stores or restaurants). Thus, a poll may be defined for a sports team, and the poll may be provided in proximity to locations that are associated with the sports team. Furthermore, the temporal constraints may define when the poll is provided, such as an event-based poll during an event (e.g., a baseball game, a concert or a television show), which may provide real-time feedback. In an exemplary embodiment, the poll may have an associated start timestamp and an associated end timestamp, where the poll is provided to the subset of the users when a current timestamps is between the start timestamp and the end timestamp. Thus, the poll may be ‘valid’ for a finite time. After a poll has expired (i.e., when the current time exceeds the end timestamp), polling system 122 may no longer provide the poll to users and/or information associated with the poll (including responses from the subset of the users) may no longer be presented or visible on the subset of portable electronic devices 110 (e.g., the poll may be deleted). However, in some embodiments the end timestamp is open or undefined, so the poll has an infinite duration.

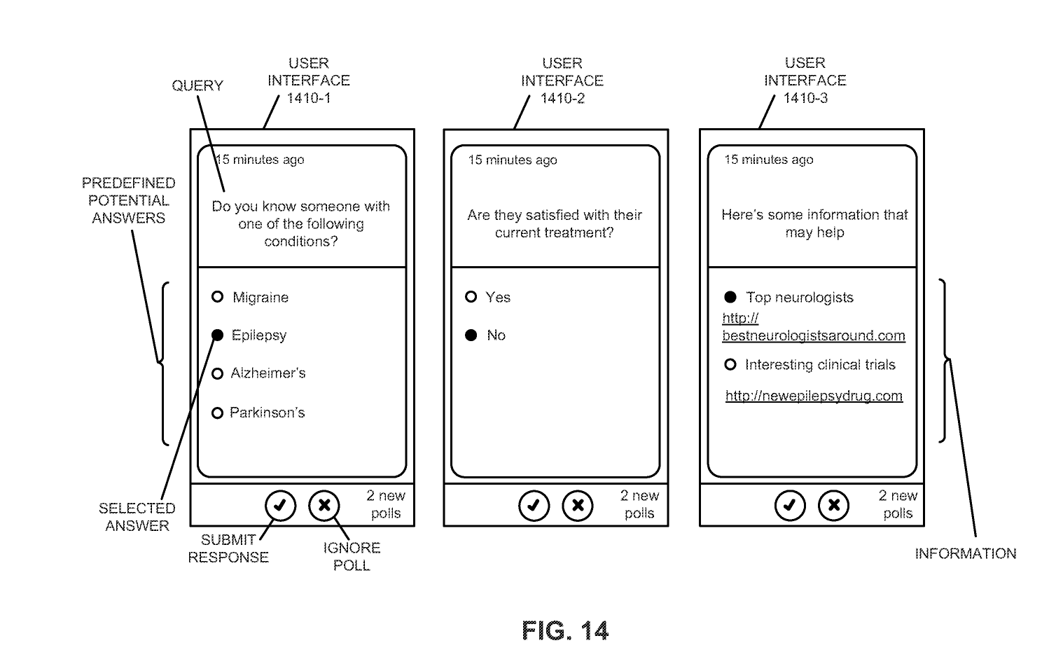

In some embodiments, the polls are used to assist the users in navigating through complicated sets of information. In particular, based on the responses and/or response histories for the subset of the users (which include responses to one or more previous polls), polling system 122 may identify links to the information. (Note that the response histories may be stored in a computer-readable storage medium or memory in or accessible to polling system 122.) For example, as described further below with reference to FIG. 14, the responses may allow a portion or a subset of a website (and, more generally, a set of documents or information), which is of interest to a user, to be identified. Then, polling system 122 may provide one or more links to information to at least the subset of portable electronic devices 110 via network 120 and the cellular-telephone network. Note that this dynamic navigation based on the responses to polls may be based on individual responses and/or the responses of a group. Thus, a link may be provided to a user which is identified based on the responses of multiple users in the subset of the users to the one or more previous polls.

Furthermore, the one or more links may be identified based on other parameters or factors, such as user interests specified in the predefined profiles of the users. Thus, users that specify an interest in sports (explicitly in their predefined profile and/or implicitly based on their behaviors, such as their responses to the one or more previous polls) may receive links to sports web pages.

Additionally, polling system 122 may correct for bias in one or more of the polls (such as response bias in a poll defined by an advertiser). In particular, as noted previously, there may be multiple versions of a particular poll, with different: layouts, colors queries and/or predefined potential answers. Polling system 122 may provide different versions of the poll to portable electronic devices associated with a test group of users. Note that a given one of portable electronic devices 110 may receive one of the versions of the poll.

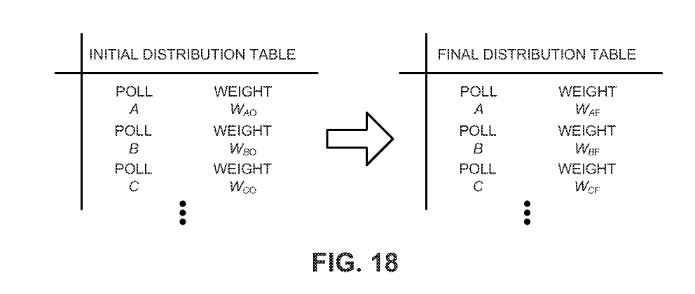

In some embodiments, polling system 122 is used to correct for bias (such as response bias) in one or more of the polls. For example, as noted previously and as described further below with reference to FIG. 18, based on the responses received from portable electronic devices associated with at least some of the test group of users, information in the predefined profiles of these users (such as their preferences and demographic information) and the target audience of the poll, polling system 122 may calculate the bias in the poll. In particular, the bias may be calculated based on the difference between the preferences and/or demographic information of the users that responded to the versions of the poll and those of the target audience. Next, polling system 122 may perform remedial action based on the calculated bias.

The remedial action may include generating a modified poll (e.g., by modifying: a color of at least one of the versions of the poll, a layout of at least one of the versions of the poll, an order of the predefined potential answers in at least one of the versions of the poll, the predefined potential answers in at least one of the versions of the poll, and/or the query in at least one of the versions of the poll). Then, polling system 122 may provide the modified poll to the portable electronic devices associated with the remaining users in the subset of the users. Alternatively or additionally, the remedial action may include determining distribution ratios of the different versions of the poll based on the bias to correct for the bias during subsequent polling. In particular, a distribution ratio of a given version of the poll may be inversely related to a number of responses to the given version of the poll in the responses divided by a total number of the responses. Thus, the distribution ratios may inversely correspond to the fractional or percentage response rates to the different versions of the poll. Next, polling system 122 may provide the different versions of the poll based on the determined distribution ratios to the portable electronic devices associated with the remaining users in the subset of the users. For example, the determined distribution ratios may be used to weight the number of instances of the different versions of the poll that are provided, so that the demographic information and/or preferences of the users who subsequently provide responses approximately match those of the target audience.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

We now further describe embodiments of the polling technique. FIG. 2 presents a flow diagram illustrating method 200 for conducting a poll that may be performed by a polling system (such as polling system 122 in FIG. 1) according to some embodiments. During operation, the polling system accesses (or obtains) location information, timestamps and predefined profiles (operation 210) of users, where the location information specifies locations of portable electronic devices associated with users at the timestamps, and the predefined profiles specify user preferences and demographic information. For example, a predefined profile may specify a given user's: age, race, income, employer, residential address, marital status, whether or not they have children, education, hobbies, vacation destinations, brands or products they like or purchase (and, more generally, the given user's shopping history), entertainment preferences (such as movies they've seen, etc.), magazines or articles they read, the rich site summary feeds to which they subscribe, their medical history and, more generally, characteristics or attributes of the given user and their behaviors.

Then, the polling system identifies a subset of the users (operation 212) based on the location information, the timestamps and/or the predefined profiles. In particular, the subset of the users may currently be located proximate to a location (such as within 100 ft or a quarter mile) or within a region that is associated with a poll (or the subset of the users may be predicted to be proximate to the location or within the region based on the location information and the timestamps). For example, the location or the region may be associated with a brand (i.e., one or more products provided by a company), a company, an educational institution and/or an organization (who are collectively sometimes referred to as ‘advertisers’ or ‘partners’) that has paid a provider of a social network (and, more generally, a provider of the polling technique) to provide the poll. In some embodiments, the location is explicitly specified when the poll is defined by an individual or an advertiser. Alternatively or additionally, the location may be indirectly specified based on the defined poll, such as the locations of retail establishments or restaurants associated with a company that is paying for the poll. Similarly, user preferences and/or demographic information in the predefined profiles may be used by the polling system to match the subset of users to demographic and preference criteria associated with a target audience of the poll. (However, in other embodiments the subset of the users is identified without a target audience, such as polls that are provided to all of the users of the social network in a region.) In some embodiments, the given user is included in the subset of the users based on whether the given user responded to a previous poll and a selected answer to the previous poll. Thus, the given user's response history to one or more previous polls may be used by the polling system when identifying the subset of the users.

Furthermore, the polling system provides, to the portable electronic devices associated with the identified subset of the users, information specifying the poll (operation 214) with a query and predefined potential answers. The providing of the poll may be gated by predefined disturbance conditions of the subset of the users, where a predefined disturbance condition of the given user indicates where and when the given user receives polls (and/or where and when the given user does not want to receive polls). For example, the given user may specify times of day and locations where they are willing to or want to receive polls, and the polling system may selectively provide polls to the given user at these times and/or locations. Additionally, the poll may have an associated start timestamp and an associated end timestamp, where the poll is provided to the subset of the users when a current timestamps is between the start timestamp and the end timestamp. Thus, the polling system may provide the poll when it is valid, i.e., after the start timestamp and before the end timestamp.

Next, the polling system receives, from at least a subset of the portable electronic devices, responses to the poll (operation 216), where a given response includes at least one of the predefined potential answers as a selected answer. However, the received responses may include user-defined answers to the query. For example, a user may type or provide a user-defined answer using a user interface in one of the portable electronic devices.

In some embodiments, the polling system optionally provides, to a portable electronic device associated with the given response, a results summary (operations 218) of the selected answers received from other portable electronic devices associated with the subset of the users. For example, the results summary may include: a most-common selected answer in the responses, selection probabilities of the predefined potential answers in the responses, and/or one or more correct answers to the query. Moreover, for the given user in the subset, the results summary may include the responses and identities of one or more users in the subset of the users associated with the given user (such as friends or colleagues of the given user), where the one or more users may be specified in a predefined profile of the given user. More generally, the polling system may provide feedback based on the received responses. This feedback may include the results summaries, incentives/rewards (such as electronic coupons or targeted discounts), additional information or content (such as links to additional information), etc.

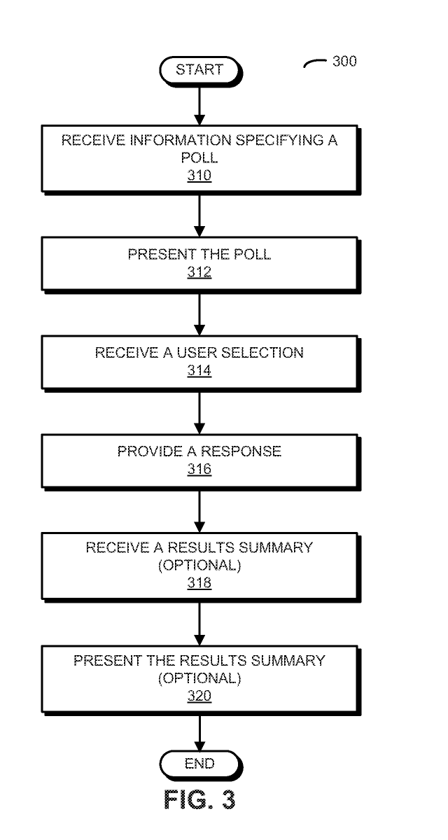

FIG. 3 presents a flow diagram illustrating method 300 for conducting a poll that may be performed by a portable electronic device (such as one of portable electronic devices 110 in FIG. 1) according to some embodiments. During operation, the portable electronic device receives, from the polling system, information specifying a poll (operation 310), which includes a query and predefined potential answers. In response, the portable electronic device presents the poll (operation 312) to a user of portable electronic device. For example, the portable electronic device may display the poll on a display. Then, the portable electronic device receives a user selection (operation 314) of one or more of the predefined potential answers (e.g., the selected answer). Next, the portable electronic device provides, to the polling system, a response (operation 316) with the user selection.

In some embodiments, the portable electronic device optionally receives, from the polling system, a results summary (operation 318), which the portable electronic device optionally presents (operation 320) to the user.

In these ways, the polling system (for example, software executed in an environment of the polling system) may dynamically provide the poll to the subset of the users, and may provide feedback to the subset of the users (such as the results summaries, incentives/rewards, additional information or content, etc.). This capability may allow the polling system to communicate information and to facilitate interaction among the users. Thus, the polling technique may allow advertisers and/or individuals to engage with interested users in the social network.

In some embodiments of methods 200 (FIG. 2) and/or 300, there may be additional or fewer operations. Moreover, the order of the operations may be changed, and/or two or more operations may be combined into a single operation.

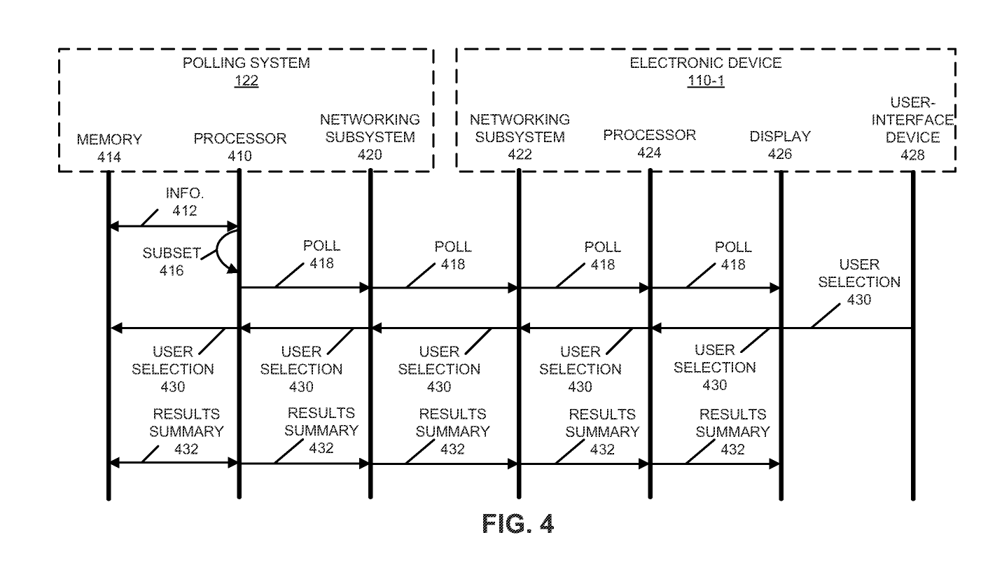

Embodiments of the polling technique are further illustrated in FIG. 4, which presents a drawing illustrating communication between one of portable electronic devices 110 in FIG. 1 (such as portable electronic device 110-1) and polling system 122. In particular, processor 410 in polling system 122 may access information 412 (such as the location information, the timestamps and/or the predefined profiles) in memory 414. Then, processor 410 may identify the subset 416. Moreover, processor 410 may provide information specifying a poll 418 to interface circuit 420 (and, more generally, a networking subsystem). In response, interface circuit 420 may provide the information specifying poll 418 to one or more portable electronic devices, such as portable electronic device 110-1.

After receiving the information specifying poll 418, an interface circuit 422 (and, more generally, a networking subsystem) may provide this information to processor 424. Then, processor 424 may present poll 418 to the user on display 426. Moreover, a user-interface device 428 may receive a user selection 430 (such as one or more predefined potential answers associated with poll 418), which is provided to processor 424. In response, processor 424 provides user selection 430 to interface circuit 422, which provides user selection 430 to polling system 122.

When interface circuit 420 receives user selection 430, it may provide user selection 430 to processor 410. Processor 410 may aggregate user selection 430 with other responses stored in memory 414. In addition processor 410 may access results summary 432 (and, more generally, feedback to user selection 430) in memory 414, which is provided to interface circuit 420. Next, interface circuit 420 provides results summary 432 to portable electronic device 110-1.

Furthermore, after receiving results summary 432, interface circuit 422 may provide results summary 432 to processor 424, which presents results summary 432 on display 426 to the user.

In an exemplary embodiment, the polling technique facilitates social interaction based on light-weight polling that provides a mechanism for asking and answering questions, such as: who wants to run with me today?; where should we eat after the game?; are you coming to the alumni mixer this weekend?; and/or what do you think of the trailer for a particular movie? The polls provide by in the polling technique may allow the users to ask for information in a structured way (as opposed to telling the user about the information).

For example, an individual or an organization may define or create a poll using a portal (such as an application programming interface) in a polling system that implements the polling technique in the context of the social network. The poll may be defined by: a query, one or more potential answers (such as categorical answers), an optional correct answer for the poll, a layout (such as color, a font, an ordering of the one or more answers, etc.), associated content (such as collateral, a picture, audio, video, etc.), meta data about the poll (such as classification information specifying a topic or theme associated with the poll), an optional target audience (such as a type of recipient, which may be specified using targeting criteria), a total budget for the poll, location criteria (such as locations where the poll will or will not be provided), the start timestamp and/or the end timestamp. The location information, the start timestamp and the end timestamp associated with a given poll may allow this poll to be targeted in space and time, and results in detailed space and time-based information that may be valuable to advertisers. For example, a poll may be conducted for a short period of time (such as a few seconds or a few minutes) in order to assess an initial reaction or response to the poll. If a user does not answer the poll within the time interval specified, their response may not be counted. (However, if the end time is not specified, the poll may be valid for an infinite time interval.) Similarly, a poll may be initiated and terminated during a specific time interval (e.g., the poll may only be published and active during this time interval). Thus, the poll may be published and then concluded during a timeout of a basketball game, because once the game resumes the poll may be meaningless or distracting. Alternatively, a poll may be initiated and terminated at a specific time of the day. For example, a so-called ‘morning coffee poll’ may be published at 9 am each day, or a so-called ‘bed time poll’ may be published at 10 pm each day. As described previously, the duration of a poll may be specified the initiator of the poll (such as an individual or an advertiser), and can have one or more windows of time it remains active.

Furthermore, a poll may be based on the amount of time needed for users to complete a specific task or action (and may also take into account parameters such as the users' location, motion, etc.). For example, a poll may be based on the amount of time it takes users to commute to work or the amount of time a user was at a specific location. Thus, the query in the poll may be: I see you were in the store for less than five minutes, were you able to find what you were looking for? Moreover, the predefined potential answers may include: yes, no, out of stock, and employee not helpful. In this example, the poll may be initiated if the user has been at a location for a very short period of time (such as less than one or five minutes), and a different poll may be provided if the user is at the location for a long period of time (such as more than 1 or five minutes). Additionally, polls may be based on the best or fastest time, the worst or slowest time, or a range of times to complete a specific task or action. For example, a poll may be sent to the given user when the user completes a specific run or bike ride along a predefined route in less than a predefined time or if the given user has one of the top-5 times, etc.

In addition, the target audience may include users of the social network that indicate they like particular products or brands (based on a specific associations in their profiles and/or based on their actions, such as their shopping histories). Alternatively or additionally, the target audience may be individuals between age 22 and 30, with a college diploma, who earn at least $60,000, and who live in California. In some embodiments, the target audience (based on targeting criteria) includes how long users: work at a specific company, go to a particular school, live in a place, etc. Thus, the polls may target: workers with more than five years at a company, seniors at a college, residents of a town who have lived there more than ten years, etc.

The polls may be presented to users of the social network so that companies (and, more generally, organizations) have an engaging way to interact with consumers (and, more generally, users of the social network who have engaged with the companies), and to obtain deep data about their customers and consumers in general. For example, product or brand-specific polls (which are sometimes referred to as ‘brand polls’) may let companies engage with consumers and obtain feedback that includes detailed demographic information about the users. Note that the engagement with the companies may be on an opt-in basis (e.g., a user may express or define an interest in a product, a brand or a company using the user preferences in their profile). Therefore, using the users' location, the time, the demographic information and/or the preferences, the polling technique may allow users to see polls that they are likely to care about, and at the relevant place and time. These polls may offer a richness of interaction and a depth of understanding of user feelings and beliefs that extend far beyond merely associating a ‘like’ tag with particular content.

Furthermore, the polling technique may be used to build community and encourage interaction among the users by allowing the users to know almost instantly the thinking of their friends and/or the community of users. For example, friends can send personal, private polls to groups of friends, and the answers may be tallied and presented to the group. Similarly, the users may be able to see the answers provided by their friends to polls (such as those associated with particular products, brands and companies). By showing users the products and brands that their friends are interacting with, the polling technique may be used to extend the reach of these products and brands.

As described previously, the polling system may receive or access location information (e.g., from a cellular-telephone network) and timestamps that specify where the users are at different times. This location information may indicate whether a user is moving or not, and how fast they are moving. In some embodiments polls are not provided to users who are in a moving vehicle, such as a car moving faster than 10 mph. As noted previously, the location information may be determined by: a cellular-telephone network, a global positioning system, a local position system, a transmitter, and/or a wireless network. For example, even if the exact location is unknown, receiving packets from an access point associated with a particular coffee vendor, may indicate that a user is proximate to one of the stores associated with this coffee vendor. Alternatively, communication with a particular electronic device (such as a hands-free headset) using Bluetooth may indicate that a user is in a particular room, is driving or is moving. Similarly, communication with a near-field-communication or radio-frequency-identification tag may specify a location. In some embodiments, audio from a microphone in a portable electronic device may provide location information. For example, the ambient noise may determine the location of a user in a city, or music playing in the background may indicate that a user is at the movies or in a theater. (In this case, a poll may be based on the song that is playing to ask the user's opinion or impression of it.)

Then, the polling system may identify the subset of the users. For example, users whose cellular telephones are proximate to or at the locations where the poll will be provided for times between the start timestamp and the end timestamp, and who meet the user preferences and/or demographic criteria associated with the target audience may be included in the subset. Thus, the polling technique may be: location-based (such as when users are at home or at a sports arena), time-based (such as at lunchtime or at half-time during a sporting event, which may provide true engagement with the audience during an event), and may let advertisers target specific users with detailed control, e.g., based on demographic information (such polls for 18-19 year olds or users who have an email address with a particular service provider), as well as based on general and/or product or brand-specific user interests. For example, a professional sports team can target users who drive high-end sports cars with polls. In some embodiments, this targeting is based on the users' responses to one or more previous polls or the users' response histories.

Consequently, polls may be based on a specific location and time interval, and may be initiated or terminated when the users enter, leave or reside at this location (e.g., polls may be based on the users' presence at the location or absence from the location). For example, when a user enters a retail establishment, they may be sent a poll about what they plan to order or if they enjoy the music being played. Alternatively, polls may be based on a particular geo-fenced area, which may be predefined and which may larger than one specific location and/or which may include multiple areas (such as a mall, a theater complex, a highway, a train, etc.). In particular, a user may send a poll to all the people in a mall about the best place to eat or where are the best deals. As noted previously, polls may occur when a user is moving, stationary or both. Thus, motion information may be included in the location information, and may be used to predict user activity. In some embodiments, a poll may be based on the locations of a user's friends. This may allow a group of friends in the same area (such as a town) to determine what they would like to do today.

Next, the polling system may provide the poll to the users. For example, the polling system may provide the poll using push notifications or using another communication technique (such as email). As noted previously, the poll may be provided to users if the current timestamp and location of the users meets the users' predefined disturbance conditions (which the users may have defined when they established their accounts with the provider of the social network). Thus, users that indicate they do not want to receive polls at certain times of the day or at certain locations will not receive polls at these times or locations. Alternatively or additionally, the users may specify when they want to receive polls, such as: during waking hours, in the morning, before work, in the evening, after work, at lunchtime, at different times on different days, based on the users' calendars (e.g., when a meeting has not been scheduled), etc. In some embodiments, polls may be silenced or cached (so the user can respond later) during a meeting or when there is a scheduled event in their calendar. In addition, the users may specify how many polls they are willing to receive per day or per hour, which will also gate the providing of polls to the users. The users may also specify particular favorite topics or categories of polls they would like to receive.

After receiving responses from a user (such as user selections of one or more predefined potential answers and/or user-defined answers), the polling system may provide the results summary to the user. The results summary may include the selected answers to a poll from multiple users in the subset. More generally, the polling technique may dynamically adapt to individual users as they interact with the polls.

In these ways, the polling technique may allow individuals and companies to obtain high-quality feedback from the users of the social network. In order to protect the privacy of the users, the user responses (other than those of a group of friends) may be anonymous. (However, in other embodiments the user responses are not anonymous.) Similarly, the demographic information and user preferences in the predefined profiles may be opt in, so the users can control when this profile information is used to provide polls. Thus, in some embodiments the polling technique allows advertisers to get the information they want (such as the responses) and to access the users, while hiding the identities of the users.

The polling technique may also be used to provide product or brand-specific rewards or incentives in response to specific answers to polls. For example, a user that matches the most-popular answer to a poll may receive a reward, such as a Quick Response code for a discount on a product that a user can display on their cellular telephone. More generally, rewards may be in the form of coupon codes that work with existing reward systems. Alternatively, a user may receive points (such as points in a loyalty program for a brand or a product) for sending a poll or answering a poll. Note that the rewards may be used as an incentive for users to offer more demographic information and/or user-interest data.

In some embodiments, the polls are provided by the polling system without charge on behalf of individuals, governmental organizations and/or non-profit organizations. For for-profit companies, there may be an incremental fee for each instance of a poll that is provided, that is viewed by a user and/or that a user answers. While the polls may, in some embodiments, exclude advertising, if a user clicks on or activates a banner (such as an image) in a poll they may be directed to a document (such as web page) that includes advertising (thus, an image in a poll may include an embedded hypertext link). Therefore, the polling system may charge fees when users click-through on banners, images, and/or other links. Furthermore, the real-time location and/or times involved in the polling (such as when a user received a poll, when they viewed it, when they responded, where they were located, etc.) may be provided to advertisers as part of a value-added service. In addition, demographic information about the users (such as those that respond to a particular poll) may be valuable to advertisers. In some embodiments, the polling system uses the location information and the timestamps (and, thus, knowledge of the users in a given area at a specific time) to dynamically recommend target audiences (who have particular characteristics in the predefined profiles) to potential advertisers.

We now describe embodiments of user interfaces associated with the polling application, executed on the portable electronic devices, that presents the polls. FIG. 5 presents a drawing illustrating a sequence of user interfaces 510 displayed on one of portable electronic devices 110 in FIG. 1 according to some embodiments. In particular, the poll presented in user interface 510-1 includes predefined potential answers that are structured. In this example, the predefined potential answers are categorical. In other embodiments, the predefined potential answers have real values. For example, a user interface may include a slider control object that allows users to adjust their responses within a range (as opposed to selecting one of a set of discrete values). In addition, a user interface may include a text entry box or control object, which allows the users to provide user-specified or user-defined answers to a query (in case the predefined potential answers are not acceptable to the users).

Moreover, as shown in user interface 510-2, the user may answer the query by selecting at least one of the predefined potential answers and clicking on or activating a submit-response icon. Note that in some polls the user may only select one of the predefined potential answers, while in other polls the user may select more than one of the predefined potential answers. (Alternatively, the user may choose to dismiss the poll without responding by clicking on or activating an ignore-poll icon, which may not impact whether the user subsequently receives another poll. However, in some embodiments, such as when the user repeatedly dismisses a set of polls, the polling system may wait for a time interval, e.g., an hour, before providing another poll to the user.)

Then, the user may be presented the results summary in user interface 510-3. The results summary may include information about the poll (such as the correct answer or the percentages for different answers) and/or other polls (such as trending or popular polls in the social network).

Note that the user may be able to share the results summary with other individuals (including those who are not currently users of the social network), e.g., by via email or a text message.

In some embodiments, the interaction with the users during a poll is state dependent based on the users' answers to one or more previous polls. This is illustrated in FIG. 6, which presents a drawing illustrating a sequence of user interfaces 610 displayed on one of portable electronic devices 110 in FIG. 1 according to some embodiments. In particular, in user interface 610-1, a company may ask users if they had a good experience at one of their restaurants. If the user answers ‘bad’ (as shown in user interface 610-2), a subsequent user interface 610-3 may ask for more information, such as was the problem the food or the service. This follow-up poll may occur when a user's answer to the first poll is received. Alternatively, there may be a delay, such as after an hour or a day, or after a user visits the restaurant again and provides the same feedback.

Furthermore, the polling technique may be used to conduct a friend-to-friend poll based a predefined group of friends (or colleagues) or an ad-hoc group that is defined by a user (which are sometimes referred to as a ‘friend poll’). This is shown in FIG. 7, which presents a drawing illustrating a sequence of user interfaces 710 displayed on one of portable electronic devices 10 in FIG. 1 according to some embodiments. While the results summary in FIG. 5 was anonymous, the responses of the friends are presented in FIG. 7. Additional information about the responses of friends can also be displayed, such as which friends responded, when they responded and/or how they responded. This is illustrated in FIG. 8, which presents a drawing illustrating a sequence of user interfaces 810 displayed on one of portable electronic devices 110 in FIG. 1 according to some embodiments.

If a user's response matches the most-common or popular answer in the subset of users, or if the user agrees to participate in a particular poll, the user may receive a reward or an incentive and, more generally, positive feedback. This is illustrated in FIG. 9, which presents a drawing illustrating a sequence of user interfaces 910 displayed on one of portable electronic devices 110 in FIG. 1 according to some embodiments.

In some embodiments, such as during a friend poll, the users in a group of friends may communicate their reactions or thoughts to each other using a chat discussion that is embedded within a user interface. This is illustrated in FIG. 10, which presents a drawing illustrating a sequence of user interfaces 1010 displayed on one of portable electronic devices 110 in FIG. 1 according to some embodiments. Note that the users can mute or disengage from the chat discussion, e.g., by clicking on or activating a mute icon in user interfaces 1010.

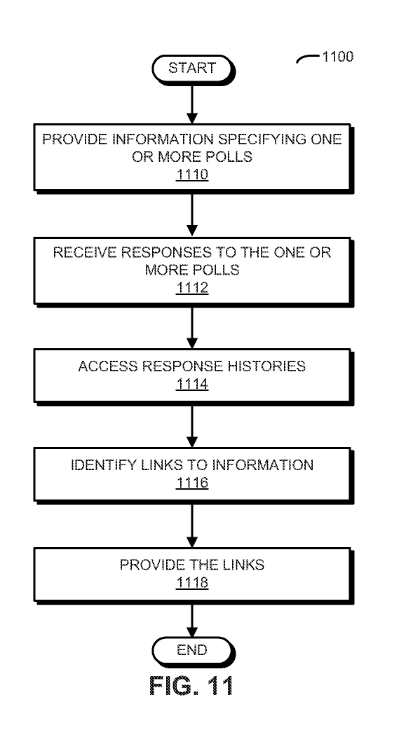

As described previously, in some embodiments the polling technique is used to help users navigate through information. For example, the polling technique may be used to help users navigate through web pages in a website. This is shown in FIG. 11, which presents a flow diagram illustrating method 1100 for navigating through information that may be performed by a polling system (such as polling system 122 in FIG. 1) according to some embodiments. During operation, the polling system provides, to the portable electronic devices associated with users, information specifying one or more polls (operation 1110), where a given poll includes a query and predefined potential answers. Then, the polling system receives, from at least a subset of the portable electronic devices, responses to the one or more polls (operation 1112), where a given response includes at least one of the predefined potential answers as a selected answer. Moreover, the polling system accesses, at memory locations in the polling system, response histories (operation 1114) for a subset of the users associated with at least the subset of the portable electronic devices, where the response histories include responses to one or more previous polls.

Next, the polling system identifies links to the information (operation 1116) based on the responses to the one or more polls and/or the responses to the one or more previous polls. For example, a link for a given user may be identified based on the given response and/or the responses by the given user to the one or more previous polls. Additionally, the link for the given user may be identified based on the responses of multiple users in the subset of the users to the one or more previous polls. For example, the average or mean selected answer by the multiple users to a previous poll may be used by the polling system to identify a link for the given user. In some embodiments, the polling system accesses, at an additional memory location in the polling system a profile of the given user, and the link provided to the given user may be identified based on demographic information and/or user interests specified in the profile. Thus, the link for the given user may be identified by the current and/or previous responses of the given user or a group of users (such as users that share common demographic information and/or user preferences).

Furthermore, the polling system provides the links to the information (operation 1118) to at least the subset of the portable electronic devices. Note that operations 1110, 1112, 1116 and 1118 may be repeated iteratively, so that successive responses from the given user may allow method 1100 to converge on a link to the information that is desired or that is of interest to the given user.

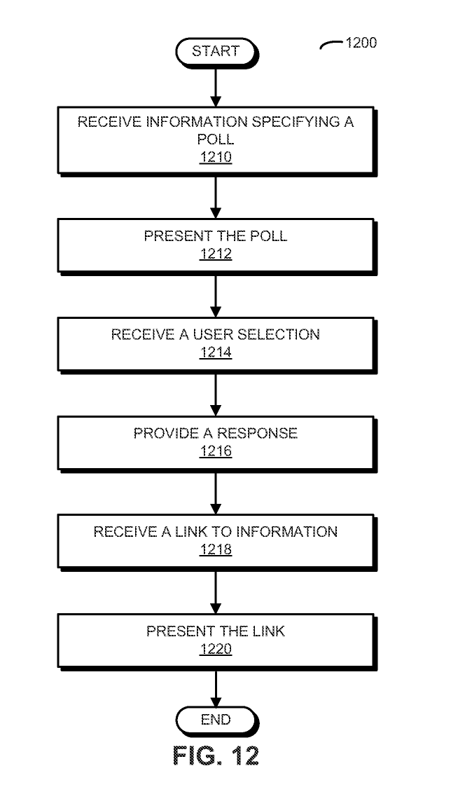

FIG. 12 presents a flow diagram illustrating method 1200 for navigating through information that may be performed by a portable electronic device (such as one of portable electronic devices 110 in FIG. 1) according to some embodiments. During operation, the portable electronic device receives, from the polling system, information specifying a poll (operation 1210), which includes a query and predefined potential answers. In response, the portable electronic device presents the poll (operation 1212) to a user of portable electronic device. For example, the portable electronic device may display the poll on a display. Then, the portable electronic device receives a user selection (operation 1214) of one or more of the predefined potential answers (i.e., the selected answer). Next, the portable electronic device provides, to the polling system, a response (operation 1216) with the user selection. Furthermore, the portable electronic device receives, from the polling system, a link to the information (operation 1218) based on the responses to the poll and/or the responses by a user of the portable electronic device to one or more previous polls. Additionally, the portable electronic device presents the link (operation 1220) to the user.

In these ways, the polling system (for example, software executed in an environment of the polling system) may allow the users to provide queries for the information in a structured manner based on the selected answers to one or more polls (such as a sequence of one or more polls). Thus, the polling system may help the user navigate through a large and complicated set of information to reach desired information that is of interest to them.

In some embodiments of methods 1100 (FIG. 11) and/or 1200, there may be additional or fewer operations. Moreover, the order of the operations may be changed, and/or two or more operations may be combined into a single operation.

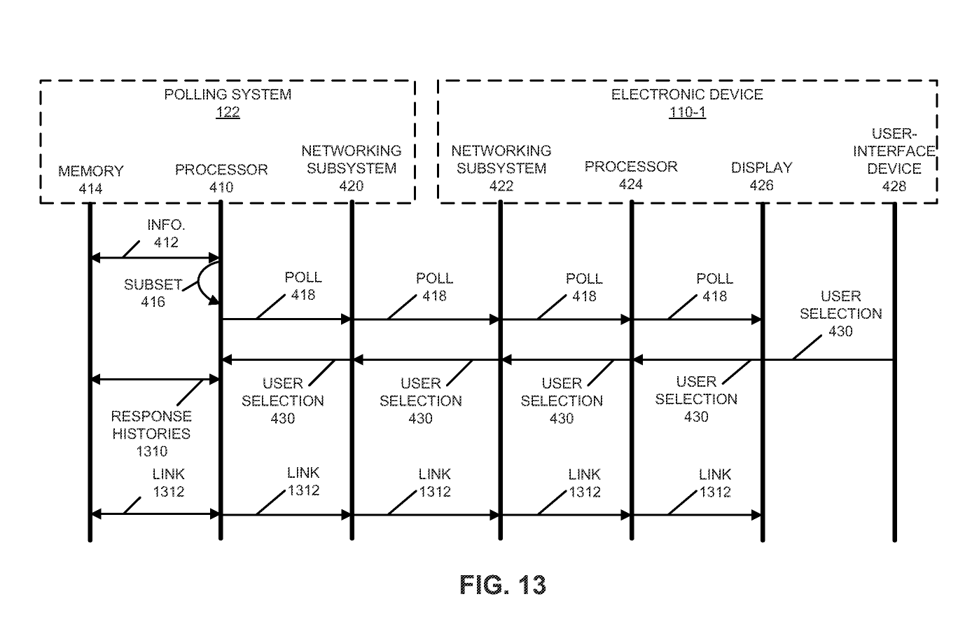

Embodiments of the polling technique are further illustrated in FIG. 13, which presents a drawing illustrating communication between one of portable electronic devices 110 in FIG. 1 (such as portable electronic device 110-1) and polling system 122. In particular, processor 410 in polling system 122 may access information 412 (such as the location information, the timestamps and/or the predefined profiles) in memory 414. Then, processor 410 may identify the subset 416. Moreover, processor 410 may provide information specifying a poll 418 to interface circuit 420. In response, interface circuit 420 may provide the information specifying poll 418 to one or more portable electronic devices, such as portable electronic device 110-1.

After receiving the information specifying poll 418, an interface circuit 422 may provide this information to processor 424. Then, processor 424 may present poll 418 to the user on display 426. Moreover, a user-interface device 428 may receive a user selection 430 (such as one or more predefined potential answers associated with poll 418), which is provided to processor 424. In response, processor 424 provides user selection 430 to interface circuit 422, which provides user selection 430 to polling system 122.

When interface circuit 420 receives user selection 430, it may provide user selection 430 to processor 410. Processor 410 may access a link 1312 (such as hypertext link) to information based on the user selection 430 in memory 414. In some embodiments, processor 410 first optionally accesses a response history 1310 of the user (with user selections in one or more previous polls) in memory 414, and processor 410 bases accessed link 1312 on user selection 430 and response history 1310. Then, processor 410 provides link 1312 to interface circuit 420. Next, interface circuit 420 provides link 1312 to portable electronic device 110-1.

Furthermore, after receiving link 1312, interface circuit 422 may provide link 1312 to processor 424, which presents link 1312 on display 426 to the user.

In an exemplary embodiment, the polling technique uses polls to assist users in navigating through information via links to accessible content. This dynamic and iterative approach may improve use of complicated sets of information, such as websites or data repositories. Notably, the users may navigate through the information in a simple and intuitive manner, without being required to learn the structure or organization of a set of information or a specific query language. Instead, the selected answers to successive polls may be used to determine a topic that is of interest to the given user and to progressively refine this topic, so that a link to the information can be provided to the given user. For example, the polls may implement a variety of search techniques through the set of information, such as binary search or a search-engine technique that navigates through the information by identifying matches between search queries (which are generated from the responses to a current poll and/or one or more previous polls) and a document repository (such as the set of information). Moreover, note that the successive polls may be provided sequentially at a given time or may be spaced out in time (such as over several hours or several days).

The use of the polling technique for navigating through information is illustrated in FIG. 14, which presents a drawing illustrating a sequence of user interfaces 1410 displayed on one of portable electronic devices 110 in FIG. 1 according to some embodiments. In particular, the selected answers to a series of polls (which may or may not be sequential) in user interfaces 1410-1 and 1410-2 are used to identify one or more links to the information, which are presented to a user in user interface 1410-3.

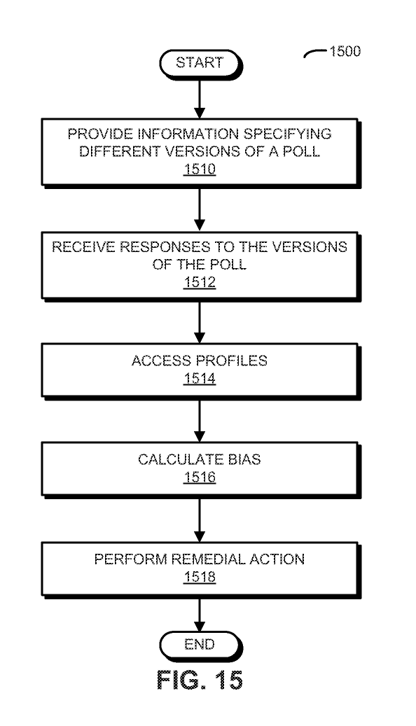

Furthermore, as described previously, in some embodiments the polling technique is used to correct for bias in a poll. This is shown in FIG. 15, which presents a flow diagram illustrating method 1500 for correcting for bias in a poll that may be performed by a polling system (such as polling system 122 in FIG. 1) according to some embodiments. During operation, the polling system provides, to the portable electronic devices associated with first users, information specifying different versions of a poll (operation 1510), where a given version of the poll includes a query and predefined potential answers, and where a given first user is provided one version of the poll. Then, the polling system receives, from at least a subset of the portable electronic devices, responses to the versions of the poll (operation 1512), where a given response includes at least one of the predefined potential answers as a selected answer. Moreover, the polling system accesses, at memory locations in the polling system, profiles (operation 1514) of a subset of the first users associated with at least the subset of the portable electronic devices, where the profiles include user preferences and/or demographic information. Next, the polling system calculates the bias (operation 1516) based on the profiles of the subset of the first users and information specifying a target audience of the poll (which may range from users having particular demographic information and/or user preferences to any user of the social network implemented by the polling system). Furthermore, the polling system performs remedial action (operation 1518) based on the calculated bias.

For example, the remedial action may include generating a modified poll by modifying: a color of at least one of the versions of the poll, a layout of at least one of the versions of the poll, an order of the predefined potential answers in at least one of the versions of the poll, the predefined potential answers in at least one of the versions of the poll, the query in at least one of the versions of the poll, and/or information associated with at least one of the versions of the poll. In some embodiments, the polling system provides, to additional portable electronic devices associated with second users (who may include or who may be different than the first users), the modified poll. In particular, the polling system may use one or more first users to test the responses to the versions of the poll, and then may provide the modified poll to the second users (who may be more numerous than the first users).

Alternatively or additionally, the remedial action may include determining distribution ratios of the different versions of the poll based on the bias to correct for the bias during subsequent polling. In particular, a distribution ratio of a given version of the poll may be inversely related to a number of responses to the given version of the poll in the responses divided by a total number of the responses to the poll and/or the given version of the poll. In some embodiments, the polling system provides, to the additional portable electronic devices associated with the second users, the different versions of the poll based on the determined distribution ratios.

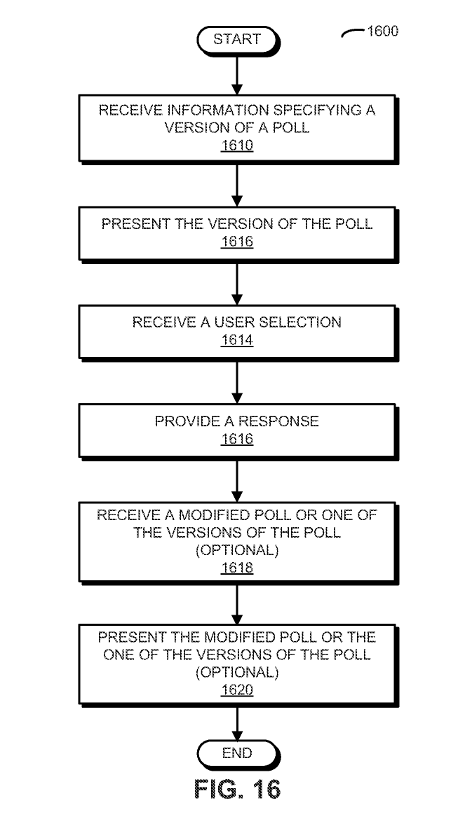

FIG. 16 presents a flow diagram illustrating method 1600 for correcting for bias in a poll that may be performed by a portable electronic device (such as one of portable electronic devices 110 in FIG. 1) according to some embodiments. During operation, the portable electronic device receives, from the polling system, information specifying a version of a poll (operation 1610), which includes a query and predefined potential answers. In response, the portable electronic device presents the version of the poll (operation 1612) to a user of portable electronic device. For example, the portable electronic device may display the version of the poll on a display. Then, the portable electronic device receives a user selection (operation 1614) of one or more of the predefined potential answers (i.e., the selected answer). Next, the portable electronic device provides, to the polling system, a response (operation 1616) with the user selection. Furthermore, the portable electronic device optionally receives the modified poll or one of the versions of the poll (operation 1618) based on the distribution ratios. (However, in some embodiments the portable electronic device does not receive the modified poll or one of the versions of the poll again. Instead, the modified poll or one of the versions of the poll may be provided to portable electronic devices of other users in the subset of the users.) Additionally, the portable electronic device optionally presents the modified poll or the one of the versions of the poll (operation 1620) to the user.

In these ways, the polling system (for example, software executed in an environment of the polling system) may use a trial-and-error approach to probe the user's reaction to a poll, and then to adapt the poll so that a desired target audience is reached. Thus, the polling technique may be used to dynamically correct for biases, such as a response bias.

In some embodiments of methods 1500 (FIG. 15) and/or 1600, there may be additional or fewer operations. Moreover, the order of the operations may be changed, and/or two or more operations may be combined into a single operation.

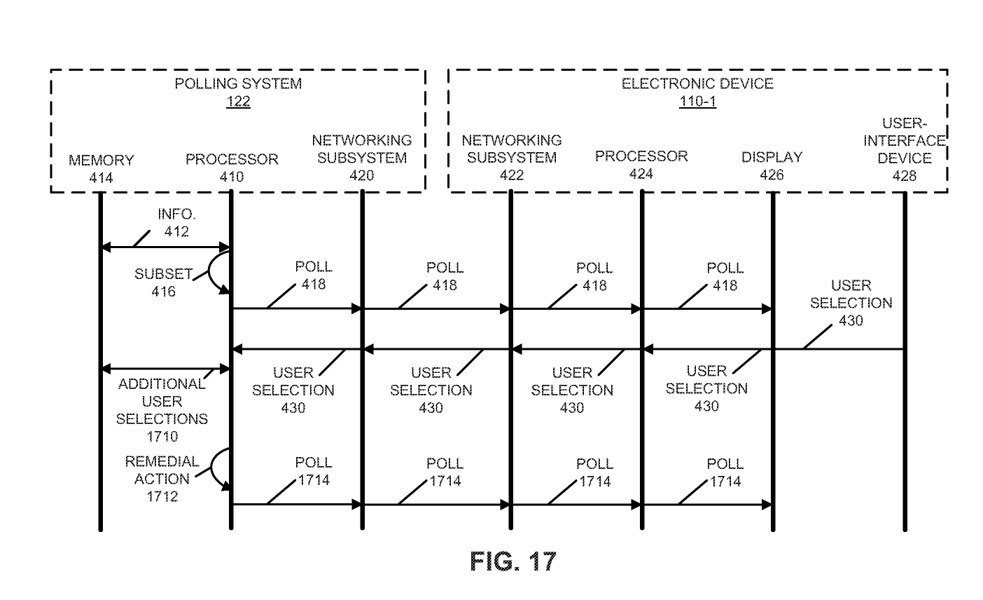

Embodiments of the polling technique are further illustrated in FIG. 17, which presents a drawing illustrating communication between one of portable electronic devices 110 in FIG. 1 (such as portable electronic device 110-1) and polling system 122. In particular, processor 410 in polling system 122 may access information 412 (such as the location information, the timestamps and/or the predefined profiles) in memory 414. Then, processor 410 may identify the subset 416. Moreover, processor 410 may provide information specifying a version of poll 418 to interface circuit 420. In response, interface circuit 420 may provide the information specifying the version of poll 418 to one or more portable electronic devices of first users in the identified subset of the users (e.g., a test group), such as portable electronic device 110-1.

After receiving the information specifying the version of poll 418, an interface circuit 422 may provide this information to processor 424. Then, processor 424 may present the version of poll 418 to the user on display 426. Moreover, a user-interface device 428 may receive a user selection 430 (such as one or more predefined potential answers associated with poll 418), which is provided to processor 424. In response, processor 424 provides user selection 430 to interface circuit 422, which provides user selection 430 to polling system 122.

When interface circuit 420 receives user selection 430, it may provide user selection 430 to processor 410. Processor 410 may access additional user responses 1710 from multiple portable electronic devices in memory 414. Moreover, processor 410 may perform the remedial action 1712. For example, processor 410 may optionally generate modified poll and/or may determine distribution ratios. Then, processor 410 may provide poll 1714 (such as one of the versions of the poll 418 based on the determined distribution ratios or the modified poll) to interface circuit 420. Next, interface circuit 420 may provide poll 1714 to portable electronic device 110-1.

Furthermore, after receiving poll 1714, interface circuit 422 may provide poll 1714 to processor 424, which presents poll 1714 on display 426 to the user. Then, operations similar to those described previously with reference to FIGS. 2-4 may be performed as the user of portable electronic device 110-1 interacts with poll 1714.

In an exemplary embodiment, the polling technique is used adapt polls to correct bias or to leverage bias to reach a targeted audience. For example, there may be four versions of a poll. These versions of the poll may be provided to the first users or a test group, which may include 10-30% of the subset of the users. For example, the subset of the users may include 10,000 users, and the versions of the poll may be provided to 1,000 of these users, where each of the 1,000 users receives one version of the poll. In particular, version A of the poll may be provided to 250 users, version B of the poll may be provided to 250 users, version C of the poll may be provided to 250 users, and version D of the poll may be provided to 250 users. Based on the received responses, the polling system may modify the poll. For example, the two polls with the highest response rates may be combined or alternating features is these polls may be selected to generate the modified poll. In some embodiments, the order of the predefined potential answers is changed in the modified poll.

Alternatively or additionally, as shown in FIG. 18, which presents a drawing illustrating correcting for bias in a poll according to some embodiments, the polling system may use the response rates for the different versions of the poll to determine a dynamic blend or weighting of the different versions of the poll in distributions tables that are used by the polling system when providing the versions of the poll to the users. In particular, the distribution ratios may be used to weight the number of instances of the different versions of the poll that are provided to the subset of the users to correct for the bias (such as the response bias), which may allow the target audience to be reached. This capability may make the polling technique more predictable. Thus, an advertiser may be told, with confidence, in advance of a full-scale rollout of the poll to the subset of the users that, for a predefined budget, the poll will reach a desired or expected target audience.

For example, the number of responses for the versions of the poll may include: 200 users for version A of the poll, 143 users for version B of the poll, 217 users for version C of the poll, and 176 users for version D of the poll. The response ratios for versions A-D of the poll are 0.8 (i.e., 200 divided by 250), 0.572, 0.868 and 0.704, respectively. The inverse of these values is 1.25, 1.748252, 1.152074 and 1.420455, respectively. Moreover, the sum of these values is 5.57078. Therefore, the normalized distribution ratios for versions A-D of the poll may be 0.224385 (i.e., 1.25 divided by 5.57078), 0.313825, 0.206807 and 0.254983, respectively. Thus, if 1,000 instances of the poll are subsequently provided to a different group of users, 224 instances of version A may be provided (i.e., the rounded value of 0.224385 times 1,000), 314 instances of version B may be provided, 207 instances of version C may be provided, and 255 instances of version D may be provided. Note that the sum of these numbers of instances of the different versions of the poll equals 1000. In addition, note that the product of the responses ratios with these number of instances of the different versions of the poll results in a uniform estimated response rate for the different versions of the poll.

We now describe embodiments of the electronic device. FIG. 19 presents a block diagram illustrating an electronic device 1900 (such as one of portable electronic devices 110 or polling system 122 in FIG. 1) according to some embodiments. This electronic device includes processing subsystem 1910, memory subsystem 1912, and networking subsystem 1914. Processing subsystem 1910 includes one or more devices configured to perform computational operations. For example, processing subsystem 1910 can include one or more microprocessors, application-specific integrated circuits (ASICs), microcontrollers, programmable-logic devices, and/or one or more digital signal processors (DSPs).

Memory subsystem 1912 includes one or more devices for storing data and/or instructions for processing subsystem 1910 and networking subsystem 1914. For example, memory subsystem 1912 can include dynamic random access memory (DRAM), static random access memory (SRAM), and/or other types of memory. In some embodiments, instructions for processing subsystem 1910 in memory subsystem 1912 include: one or more program modules or sets of instructions (such as program module 1922 or operating system 1924), which may be executed by processing subsystem 1910. Note that the one or more computer programs may constitute a computer-program mechanism. Moreover, instructions in the various modules in memory subsystem 1912 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1910.

In addition, memory subsystem 1912 can include mechanisms for controlling access to the memory. In some embodiments, memory subsystem 1912 includes a memory hierarchy that comprises one or more caches coupled to a memory in electronic device 1900. In some of these embodiments, one or more of the caches is located in processing subsystem 1910.

In some embodiments, memory subsystem 1912 is coupled to one or more high-capacity mass-storage devices (not shown). For example, memory subsystem 1912 can be coupled to a magnetic or optical drive, a solid-state drive, or another type of mass-storage device. In these embodiments, memory subsystem 1912 can be used by electronic device 1900 as fast-access storage for often-used data, while the mass-storage device is used to store less frequently used data.

Networking subsystem 1914 includes one or more devices configured to couple to and communicate on a wired and/or wireless network (i.e., to perform network operations), including: control logic 1916, an interface circuit 1918 and one or more optional antennas 1920. (While FIG. 19 includes the one or more optional antennas 1920, in some embodiments electronic device 1900 includes one or more nodes, such as node 1908, e.g., a pad, which can be coupled to the one or more optional antennas 1920. Thus, electronic device 1900 may or may not include the one or more optional antennas 1920.) For example, networking subsystem 1914 can include a Bluetooth networking system, a cellular networking system (e.g., a 3G/4G network such as UWMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 1914 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 1900 may use the mechanisms in networking subsystem 1914 for performing simple wireless communication between the electronic devices, e.g., transmitting advertising or beacon frames and/or scanning for advertising frames transmitted by other electronic devices.

Within electronic device 1900, processing subsystem 1910, memory subsystem 1912, and networking subsystem 1914 are coupled together using bus 1928. Bus 1928 may include an electrical, optical, and/or electro-optical connection that the subsystems can use to communicate commands and data among one another. Although only one bus 1928 is shown for clarity, different embodiments can include a different number or configuration of electrical, optical, and/or electro-optical connections among the subsystems.

In some embodiments, electronic device 1900 includes a display subsystem 1926 for displaying information on a display, which may include a display driver and the display, such as a liquid-crystal display, a multi-touch touchscreen, etc.

Electronic device 1900 can be (or can be included in) any electronic device with at least one network interface. For example, electronic device 1900 can be (or can be included in): a desktop computer, a laptop computer, a subnotebook/netbook, a server, a tablet computer, a smartphone, a cellular telephone, a consumer-electronic device, a portable computing device, and/or another electronic device.

Although specific components are used to describe electronic device 1900, in alternative embodiments, different components and/or subsystems may be present in electronic device 1900. For example, electronic device 1900 may include one or more additional processing subsystems 1910, memory subsystems 1912, networking subsystems 1914, and/or display subsystems 1926. Additionally, one or more of the subsystems may not be present in electronic device 1900. Moreover, in some embodiments, electronic device 1900 may include one or more additional subsystems that are not shown in FIG. 19. Also, although separate subsystems are shown in FIG. 19, in some embodiments, some or all of a given subsystem or component can be integrated into one or more of the other subsystems or component(s) in electronic device 1900. For example, in some embodiments program module 1922 is included in operating system 1924.

Moreover, the circuits and components in electronic device 1900 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1914, such as a radio. Moreover, the integrated circuit may include hardware and/or software mechanisms that are used for transmitting wireless signals from electronic device 1900 and receiving signals at electronic device 1900 from other electronic devices. Aside from the mechanisms herein described, radios are generally known in the art and hence are not described in detail. In general, networking subsystem 1914 and/or the integrated circuit can include any number of radios. Note that the radios in multiple-radio embodiments function in a similar way to the described single-radio embodiments.

In some embodiments, networking subsystem 1914 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals.)

While a communication protocol compatible with a cellular-telephone network were used as an illustrative example, the described embodiments of the polling technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the polling technique may be implemented using program module 1922, operating system 1924 (such as a driver for interface circuit 1918) or in firmware in interface circuit 1918. Alternatively or additionally, at least some of the operations in the polling technique may be implemented in a physical layer, such as hardware in interface circuit 1918.

Moreover, while a social network has been used as an illustration in the preceding embodiments, more generally the polling technique may be used to conduct polls in a wide variety of applications or systems. Moreover, the polling technique may be used in applications where the communication or interactions among different entities (such as people, organizations, etc.) can be described by a social graph with nodes representing the entities coupled by branches that represent interactions or connections among the entities. Note that the people may be loosely affiliated each other (such as viewers or users of the website), as opposed to people who are formally associated (such as users of a social network who have user accounts or predefined profiles). Thus, the connections in the social graph may be defined less stringently than by the explicit acceptance of requests by individuals to associate or establish connections with each other, such as people who have previously communicated with each other (or not) using a communication protocol, etc. In this way, the polling technique may be used to expand the quality of interactions and value-added services among relevant or potentially interested people in a more loosely defined group of people.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with portable electronic devices via a network;
a processor, and
memory, coupled to the processor, which stores location information, timestamps and predefined profiles of users, and which stores a program module configured to be executed by the processor to provide a poll, the program module including:
instructions for accessing, at memory locations, the location information, the timestamps and the predefined profiles of users, wherein the location information specifies locations of the portable electronic devices associated with the users at the timestamps, and the predefined profiles specify user preferences and demographic information;
instructions for identifying a subset of the users based on the location information, the timestamps and the predefined profiles;
instructions for providing, to the portable electronic devices associated with the identified subset of the users, the poll with a query and predefined potential answers; and
instructions for receiving, from at least a subset of the portable electronic devices, responses to the poll, wherein a given response includes at least one of the predefined potential answers as a selected answer.

2. The computer system of claim 1, wherein the program module further includes instructions for providing, to a portable electronic device associated with the given response, a results summary of the selected answers received from other portable electronic devices associated with the subset of the users.

3. The computer system of claim 2, wherein the results summary includes one of: a most-common selected answer, selection probabilities of the predefined potential answers, and one or more correct answers to the query.

4. The computer system of claim 2, wherein, for a given user, the results summary includes the responses and identities of one or more users in the subset of the users associated with the given user; and
wherein the one or more users are specified in a predefined profile of the given user.

5. The computer system of claim 1, wherein the received responses include user-defined answers to the query.

6. The computer system of claim 1, wherein providing the poll is gated by predefined disturbance conditions of the subset of the users; and
wherein a predefined disturbance condition of a given user indicates where and when the given user receives polls.

7. The computer system of claim 1, wherein the poll has an associated start timestamp and an associated end timestamp; and
wherein the poll is provided to the subset of the users when a current timestamps is between the start timestamp and the end timestamp.

8. The computer system of claim 1, where a given user is included in the subset of the users based on whether the given user responded to a previous poll and a selected answer to the previous poll.

9. The computer system of claim 1, where the poll includes multiple versions of the poll; and
wherein a given portable electronic device receives one of the versions of the poll.

10. A computer-program product for use in conjunction with a computer system, the computer-program product comprising a non-transitory computer-readable storage medium and a computer-program mechanism embedded therein to provide a poll, the computer-program mechanism including:
instructions for accessing, at memory locations in the computer system, location information, timestamps and predefined profiles of users, wherein the profiles specify user preferences, wherein the location information specifies locations of portable electronic devices associated with the users at the timestamps, and the predefined profiles specify user preferences and demographic information;
instructions for identifying a subset of the users based on the location information, the timestamps and the predefined profiles;
instructions for providing, to the portable electronic devices associated with the identified subset of the users, the poll with a query and predefined potential answers; and
instructions for receiving, from at least a subset of the portable electronic devices, responses to the poll, wherein a given response includes at least one of the predefined potential answers as a selected answer.

11. The computer-program product of claim 10, wherein the computer-program mechanism further includes instructions for providing, to a portable electronic device associated with the given response, a results summary of the selected answers received from other portable electronic devices associated with the subset of the users.

12. A computer-implemented method for conducting a poll, the method comprising:
accessing, at memory locations, location information, timestamps and predefined profiles of users, wherein the location information specifies locations of portable electronic devices associated with users at the timestamps, and the predefined profiles specify user preferences and demographic information;
using a computer processor in the computer system that is coupled to the memory locations and programmed to analyze the location information, the timestamps and the predefined profiles, identifying a subset of the users based on the location information, the timestamps and the predefined profiles;
providing, to the portable electronic devices associated with the identified subset of the users, the poll with a query and predefined potential answers; and
receiving, from at least a subset of the portable electronic devices, responses to the poll, wherein a given response includes at least one of the predefined potential answers as a selected answer.

13. The method of claim 12, wherein, in response to receiving the given response, the method further comprises providing, to a portable electronic device associated with the given response, a results summary of the selected answers received from other portable electronic devices associated with the subset of the users.

14. The method of claim 13, wherein the results summary includes one of: a most-common selected answer, selection probabilities of the predefined potential answers, and one or more correct answers to the query.

15. The method of claim 13, wherein, for a given user, the results summary includes the responses and identities of one or more users in the subset of the users associated with the given user; and
wherein the one or more users are specified in a predefined profile of the given user.

16. The method of claim 12, wherein the received responses include user-defined answers to the query.

17. The method of claim 12, wherein providing the poll is gated by predefined disturbance conditions of the subset of the users; and
wherein a predefined disturbance condition of a given user indicates where and when the given user receives polls.

18. The method of claim 12, wherein the poll has an associated start timestamp and an associated end timestamp; and
wherein the poll is provided to the subset of the users when a current timestamp is between the start timestamp and the end timestamp.

19. The method of claim 12, where a given user is included in the subset of the users based on whether the given user responded to a previous poll and a selected answer to the previous poll.

20. The method of claim 12, where the poll includes multiple versions of the poll; and
wherein a given portable electronic device receives one of the versions of the poll.
